(19) United States
(12) Patent Application Publication
(10) Pub. No.: US 2023/0168230 A1
(43) Pub. Date: Jun. 1, 2023

(54) LC COLUMN HANDLING USING WEIGHTED COUNTERS

(71) Applicant: Roche Diagnostics Operations, Inc., Indianapolis, IN (US)

(72) Inventors: Daniel Intelmann, München Süd (DE); Katrin Koenig, München Süd (DE); Patrick Neiens, München Süd (DE); Tibor Toth, München Süd (DE)

(21) Appl. No.: 18/096,477

(22) Filed: Jan. 12, 2023

Related U.S. Application Data
(63) Continuation of application No. PCT/EP2021/069600, filed on Jul. 14, 2021.

(30) Foreign Application Priority Data
Jul. 15, 2020 (EP) 20185971.7
Jan. 29, 2021 (EP) 21154391.3

(51) Int. Cl. G01N 30/88; G01N 30/86

(52) U.S. Cl. CPC G01N 30/88; G01N 30/8658; G01N 2030/889

(57) ABSTRACT

The present invention relates to a method for operating a chromatography column comprising (a) providing a first value of a lifetime (first lifetime value) of said chromatography column; (b) performing a chromatographic separation of a sample on said chromatography column; (c) providing a value of a weighted aging factor determined based on at least one aging parameter selected from sample type, sample dilution, and sample volume; and (d) determining a second value of said lifetime (second lifetime value) of said chromatography column based on said first lifetime value and said weighted aging factor. The present invention also relates to further methods, databases, devices, and uses related thereto.

The present invention relates to a method for operating a chromatography column comprising (a) providing a first value of a lifetime (first lifetime value) of said chromatography column: (b) performing a chromatographic separation of a sample on said chromatography column: (c) providing a value of a weighted aging factor determined based on at least one aging parameter selected from sample type, sample dilution, and sample volume; and (d) determining a second value of said lifetime (second lifetime value) of said chromatography column based on said first lifetime value and said weighted aging factor. The present invention also relates to further methods, databases, devices, and uses related thereto.

LC columns usually have a lifetime predefined by a number of injections (simple counter, e.g. as described in EP 2 880 437 A1). After this number of injections is reached, a column is no longer used. Alternatively, in some laboratories, a column may be used as long as its performance is within specified acceptance criteria. Thus, it has been proposed to estimate a lifetime of a piece of equipment based on the time and temperature it has been maintained in (U.S. Pat. No. 8,279,072 B2). Also, monitoring of chromatography columns was proposed based on pressure (EP 2,771,683 A1) or other output parameters of a column (EP 2,338,049 A1).

By using a simple counter, the status of the columns is not controlled, thus columns with sufficient performance may be nonetheless be excluded from further use. Additionally, the simple counter is of limited use when a single assay is performed with an LC column. Moreover, in random access uses, variances in e.g. matrix load in different assays am not taken into account with a simple counter. This means that the maximum number of injections for a column has to be defined by the most demanding assay in such cases, leading to additional cost.

In the converse, with a simple counter, it is possible that a column does no longer deliver suitable performance for the assay of interest even before it reaches its maximum number of injections. In this case, the column is not replaced although its performance is insufficient, possibly leading to false results.

On the other hand, if column lifetime is determined based on its performance, there is no estimation about the column lifetime possible, thus a column exchange cannot be planned.

The technical problem underlying the present invention may be seen in the provision of means and methods complying with the aforementioned needs, avoiding the problems identified as far as possible. The technical problem is solved by the embodiments characterized in the claims and described herein below.

In accordance, the present invention relates to a method for operating a chromatography column comprising

(a) providing a first value of a lifetime (first lifetime value) of said column;

(b) performing a chromatographic separation of a sample on said chromatography column:

(c) providing a value of a weighted aging factor determined based on at least one aging parameter selected from sample type, sample dilution, and sample volume; and

(d) determining a second value of said lifetime (second lifetime value) of said chromatography column based on said first lifetime value and said weighted aging factor.

In general, terms used herein are to be given their ordinary and customary meaning to a person of ordinary skill in the art and, unless indicated otherwise, are not to be limited to a special or customized meaning. As used in the following, the terms “have”, “comprise” or “include” or any arbitrary grammatical variations thereof are used in a non-exclusive way.

Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements. Also, as is understood by the skilled person, the expressions “comprising a” and “comprising an” preferably refer to “comprising one or more”, i.e. are equivalent to “comprising at least one”. As used herein, the term “multitude” relates to a number of at least two, in an embodiment at least three, in a further embodiment at least four, in a further embodiment at least five, in a further embodiment at least ten.

Further, as used in the following, the terms “preferably”. “more preferably”. “most preferably”. “particularly”, “more particularly”. “specifically”, “more specifically” or similar terms are used in conjunction with optional features, without restricting further possibilities.

Thus, features introduced by these terms are optional features and are not intended to restrict the scope of the claims in any way. The invention may, as the skilled person will recognize, be performed by using alternative features. Similarly, features introduced by “in at embodiment” or similar expressions are intended to be optional features, without any restriction regarding further embodiments of the invention, without any restrictions regarding the scope of the invention and without any restriction regarding the possibility of combining the features introduced in such way with other optional or non-optional features of the invention.

As used herein, the term “standard conditions”, if not otherwise noted, relates to IUPAC standard ambient temperature and pressure (SATP) conditions, i.e. preferably, a temperature of 25° C. and an absolute pressure of 100 kPa; also preferably, standard conditions include a pH of 7. Moreover, if not otherwise indicated, the term “about” relates to the indicated value with the commonly accepted technical precision in the relevant field, preferably relates to the indicated value ±20%, more preferably ±10%, most preferably ±5%. Further, the term “essentially” indicates that deviations having influence on the indicated result or use are absent. i.e. potential deviations do not cause the indicated result to deviate by more than ±20%, more preferably ±10%, most preferably ±5%. Thus. “consisting essentially of” means including the components specified but excluding other components except for materials present as impurities, unavoidable materials present as a result of processes used to provide the components, and components added for a purpose other than achieving the technical effect of the invention. For example, a composition defined using the phrase “consisting essentially of” encompasses any known acceptable additive, excipient, diluent, carrier, and the like. Preferably, a composition consisting essentially of a set of components will comprise less than 5% by weight, more preferably less than 3% by weight, even more preferably less than 1% by weight, most preferably less than 0.1% by weight of non-specified component(s).

The methods described herein are in vitro methods and, in an embodiment, at least one step is assisted or performed by automated equipment. The whole methods may also be implemented on such automated equipment; e.g. on a chromatographic analysis system. The steps described may, as far as technically possible, be performed in any arbitrary order, however, in a further embodiment, are performed in the given order. Moreover, the methods may comprise steps in addition to those explicitly mentioned above.

The term “chromatography column” is understood by the skilled person. In an embodiment, the term relates to a, typically cylindrical, container comprising a stationary phase and having an inlet and an outlet for a mobile phase, in an embodiment a liquid or a gas, in a further embodiment a liquid, in an embodiment an aqueous chromatography solvent. In an embodiment, the chromatography column is a liquid chromatography (LC) column, in a further embodiment a high-performance liquid chromatography (HPLC) or fast-performance liquid chromatography (FPLC) column. Appropriate stationary phase materials and mobile phases and their combinations are known in the art.

The term “operating a chromatography column” is understood by the skilled person as well. In an embodiment, the term relates to a single use of a chromatography column for a chromatographic separation; in a further embodiment, the term relates to a use of a chromatography column for a series of chromatographic separations, wherein said chromatographic separations may be separations according to the same protocol, or according to different protocols. As specified in more detail elsewhere herein, operating a chromatography column may comprise operating said chromatography column under a first protocol until a reference value of a second lifetime value is reached, after which the chromatography column is operated under a second, in an embodiment less demanding, protocol. As is understood by the skilled person, the aforesaid change of protocol based on a second lifetime value may be repealed.

The term “chromatography protocol”, also referred to as “protocol”, relates to the sum of chromatography parameters applied to a chromatography column. i.e., in particular the specific mobile phase or gradient thereof, temperature, pressure, flow rate, and sample type. The term “assay”, as used herein, relates to the sum of parameters defining a protocol, further including the chromatography column to be used and the analysis to be performed, in particular the analyte(s) to be determined, as well as sample preparation steps, such as those specified elsewhere herein. Thus, on a specific chromatography column, it is, in principle, possible to detect several non-identical analytes using the same protocol. i.e. to use the same protocol for more than one non-identical assay. It is, however, also possible to detect the same analyte with different protocols. As is clear from the above, using different protocols for the detection of the same analyte(s), as well as using the same protocol for detecting different analyte(s), in each case defines a specific assay. In contrast, the term “separation”, which may also be referred to as “run”, relates to a single event of performing a chromatography using a specific chromatography column, in an embodiment independent of protocol and/or assay. Nonetheless, a separation is typically performed using one specific protocol and is performed in the context of a particular assay. In an embodiment, a chromatography protocol comprises eluent pH and pressure conditions.

As used herein, the term “eluent pH” relates to the pH of the eluent(s) used in a chromatography protocol, including any gradients thereof; as is understood by the skilled person, the eluent pH results from the mixture of mobile phases with different additives and buffers. In an embodiment, in Random Access mode, eluent pH is changed frequently and has a major impact on column lifetime. E.g. silica bound stationary phases in an analytical column may wear out at neutral to high pH values, as the silica bonds get dissolved. This may lead to “column bleeding” and reduced column lifetime.

In an embodiment, the term “column hack pressure” relates to the back pressure on a chromatography column caused by the flow of mobile phase coming from the HPLC pump and flowing through the chromatography column, e.g. to the detector. The column back pressure is usually measured by a pressure sensor in between the HPLC pump heads and the chromatography column. In contrast, as used herein, the term “pressure conditions”, in an embodiment, relates to the back pressure to be expected on a particular column type when a particular protocol, in an embodiment at least mobile phase (eluent) and flow rate, is applied to said column type: thus, the term pressure conditions, in an embodiment, does not relate to the back pressure measured or measurable for a particular column under its operating conditions, which is referred to as column back pressure as specified above. As is understood by the skilled person, pressure conditions for a particular protocol can in an embodiment be pre-determined by determining the column back pressure for said protocol on the specific type of chromatography column, in an embodiment for at least one, in a further embodiment at least two columns of said type. High pressure conditions, in an embodiment, may lead to deformation of the stationary phase bed, especially at the entrance of the chromatography column and may lead to reduced chromatographic performance and reduced column lifetime.

High pressure conditions, in an embodiment, reduce chromatography column lifetime more than a low back pressure. The pressure conditions on the chromatography column are influenced by e.g. the following parameters: the flow rate of the mobile phase, the viscosity of the mobile phase, the column dimensions, and the particle size. The viscosity of the mobile phase, in an embodiment, is influenced by the change of organic solvent content over a gradient and/or by the type of organic solvent (e.g. the mixture of acetonitrile/water has a lower viscosity than the mixture of methanol/water). The chromatography column dimensions and the particle size do not change during e.g. random access operation mode of the column, but the flow rate and the viscosity may be changed frequently, thereby changing pressure conditions.

The term “lifetime” of a chromatography column relates to a parameter indicative of wear inflicted on a chromatography column by past separations performed thereon. In an embodiment, the lifetime is a remaining lifetime, i.e. a parameter indicative of how many separations are expected to be possible using the chromatography column before column performance becomes inacceptable; as will be understood, the weighted aging factor and potential further factors are typically applied in a count-down manner in such case. In a further embodiment, the lifetime is a spent lifetime, i.e. a parameter indicative of how many separations are were already performed using the chromatography column; as will be understood, the weighted aging factor and potential further factors are typically applied in a count-up manner in such case. Thus, the lifetime may be indicated as a number of remaining runs in the case of a remaining lifetime, or may be a number of cumulated runs in the case of a spent lifetime. It is, however, also envisaged that the lifetime is an abstract value; e.g. a lifetime may also be indicated as a calculated fraction of initial performance or as a lifetime score, in an embodiment with arbitrary units, or any other parameter deemed appropriate by the skilled person. The lifetime of a chromatography column, as is understood by the skilled person, is a column-specific parameter. The lifetime of a chromatography column, in an embodiment, further is a protocol-specific, in an embodiment assay-specific, parameter; i.e., in an embodiment, different protocols, in particular assays, vary in how demanding they are with regards to column performance and, therefore, the value of the lifetime may be different for different protocols and/or assays. Thus, a chromatography column may have reached the end of its remaining lifetime for a demanding assay, while it may still be usable in a less demanding assay. The first and second lifetime parameters, in an embodiment, are determined as specified herein below. It an embodiment, the value of the first lifetime parameter is the value of the initial lifetime of a chromatography column (“initial lifetime value”), i.e., in an embodiment, the lifetime value of the chromatography column before the first run. The initial lifetime value may be provided by the manufacturer of the chromatography column, may be based on experience with similar chromatography columns, and/or may be experimentally determined. The initial lifetime value may be further corrected for individual properties of the specific column and/or the specific protocol and/or assay the column is planned to be used for. As the skilled person will understand from the above, the initial lifetime value, in an embodiment, is a column type specific value, in an embodiment a column-specific value, and/or a protocol, in an embodiment assay-specific, value. As a consequence, in case the protocol, in an embodiment the assay, the chromatography column is used for is changed, the initial lifetime value may change as well.

The second lifetime value is provided as specified herein below. In an embodiment, the second lifetime value is the current lifetime value. i.e. the lifetime value applicable after the immediately preceding separation.

The term “aging parameter”, as used herein, relates to any parameter contributing to wear of a chromatography column and, thus, having an impact on the lifetime of the chromatography column. The aging parameter, in an embodiment, is a quantitative parameter, i.e. is a quantifiable parameter, such as e.g. sample dilution. In a further embodiment, the aging parameter is a semiquantitative or qualitative parameter. i.e. a parameter which as such cannot be quantified or is impractical to quantify, such as sample matrix. In such case, in an embodiment in all cases, the aging parameter is divided into categories (“aging parameter categories”) and a numerical value is assigned to each category, wherein the assigned numerical value (the “aging parameter factor”) correlates with the impact of said category on a chromatography column lifetime. Thus, an aging parameter may comprise a descriptor of category and an assigned aging parameter factor. In accordance, the specification of an aging parameter, e.g. in a database, in an embodiment, may comprise aging parameter categories such as e.g. “whole blood”. “serum”, plasma”. “saliva”, and the like as descriptors of sample matrix, and/or categories such as “non-purified”, “solvent precipitated”. “affinity-purified” and the like as descriptors of purification state, in each case assigned to a numerical value of an aging parameter factor. For other aging parameters, in particular for quantifiable aging parameters, the actual value or a value derived therefrom by standard mathematical operations may be used as aging parameter category. E.g., in an embodiment, the value of the sample dilution may be used as such; and/or the reciprocal of the value of the sample volume may be used. Thus, in case of a quantifiable aging parameter category, the aging parameter category and the aging parameter factor may have the same value: or the aging parameter may only be assigned one (numerical) value. However, in particular in cases where the correlation between an aging parameter and lifetime is non-proportional, assignment of an aging parameter category and an assigned aging parameter factor, wherein the aging parameter category and the assigned aging parameter factor have non-identical numerical values may be envisaged. In an embodiment, the aging parameter category may also be a range of values, in particular numerical values. Aging parameter factors may be provided by any means deemed appropriate by the skilled person, in an embodiment as specified herein below. In an embodiment, aging parameter factors may be determined experimentally by performing test separations under conditions including the respective aging parameter(s) and determining the impact on chromatography column lifetime. In an embodiment, said aging parameter factor(s) is/are determined concomitant to practical use of a chromatography column. e.g. by determining one or more performance parameter. In an embodiment, the aging parameter is a parameter of a particular kind of sample used in a specific assay and, thus, may be provided in a database, in an embodiment a database as specified herein below; thus, in an embodiment, the aging parameter is not a parameter specific for an individual sample. In an embodiment, the aging parameter is selected from the list consisting of sample type, sample dilution, sample volume, time since a preceding use, storage conditions since a preceding use, and set of chromatography conditions applied, wherein, in an embodiment, the set of chromatography conditions comprises some or all of the conditions defining a chromatography protocol, and optionally a parameter indicative of whether a solvent exchange is required. Thus, in an embodiment, the aging parameter is a sample specific aging parameter, in particular selected from sample type, sample dilution, and sample volume; or is an operation specific parameter, in particular an assay specific parameter, a time since a preceding use, storage conditions since a preceding use, and/or a parameter indicative of whether a solvent exchange is required, wherein an assay specific aging parameter in particular may be an eluent pH4 and/or pressure conditions.

The term “performance parameter” is, in principle, known to the skilled person as including any measurable parameter indicative of the suitability of a chromatography column for a separation purpose. In an embodiment, the performance parameter is selected from the list consisting of retention time of an analyte, peak width, peak symmetry, resolution, break-through point, and column pressure. In an embodiment, at least one of the aforesaid performance parameters is determined in-line during use of the chromatography column.

The term “sample type”, as used herein, includes each and every parameter influencing the type and amount of sample constituents. In an embodiment the sample type is defined at least by sample matrix and pre-purification state of said sample. The term “sample matrix” is known to relate to the entirety of non-analyte constituents of a sample; sample matrix is, in an embodiment. defined by sample origin. e.g., in an embodiment, as a bodily fluid sample, such, as whole blood, serum, plasma, urine, saliva, or sputum; or as a tissue sample, such as biopsy material. The term “pre-purification state” of a sample relates the entirety of measures applied to a sample after it was obtained, which at least partially remove sample constituents, in particular matrix constituents. Pre-purification steps are known in the art and include in particular centrifugation, precipitation, solvent treatment, extraction, homogenization, heat treatment, freezing and thawing, lysis of cells, application to a pre-column, and the like, in an embodiment as specified elsewhere herein. As will be understood from the above, as used herein, any differences in pre-purification steps causing sample constituents to differ, in an embodiment, are considered to provide different sample types: thus, e.g. a low-speed centrifuged serum sample and an ultracentrifuged scrum sample may be different sample types.

The term “sample dilution” is used herein in its conventional meaning, as are the terms “sample volume”, “time since a preceding use”, and “storage conditions since a preceding use”, wherein storage conditions since a preceding use, in an embodiment, in particular include storage temperature.

The term “set of chromatography conditions”, as used herein, relates to a subset or the complete set of chromatography conditions defining a protocol as specified herein above; in an embodiment, e.g. performing a chromatography at a temperature of 60° C. may have a different impact on chromatography column lifetime compared to an otherwise identical protocol performed at a temperature of 4° C. In an embodiment, the set of chromatography conditions comprises some or all of the conditions defining a chromatography protocol, and optionally a parameter indicative of whether a solvent exchange is required.

As used herein, the term “solvent exchange”, relates to the exchange of mobile phase in a chromatography pump, in an embodiment in the pump heads. In random access operation mode of a chromatography column, different assays may need different mobile phase mixtures. The mixture of the previous run may need to be removed from the pump heads and the mixture for the next mobile phase mixture be pumped. During this solvent exchange process, there is no flow of mobile phase onto the column, causing a, in an embodiment sudden, decrease of back pressure and, at the end of the process a, in an embodiment sudden, increase of back pressure onto the analytical head, as the new mobile phase is pumped onto the chromatography column. The sudden decrease and increase of pressure (“pressure shock”) may lead to deformation of the stationary phase bed in the chromatography column and may reduce column lifetime with every solvent exchange process.

The term “aging factor”, as used herein, relates to a parameter indicative of change of a lifetime of a chromatography column induced by one or more chromatographic separation(s). The value of the aging factor depends on how the lifetime parameter is provided: e.g. in case the lifetime is a remaining lifetime provided as number of remaining chromatographic runs, the aging factor may be a subtrahend. Conversely, in case the lifetime is provided as spent lifetime. e.g. as number of runs already performed, the aging factor may be a summand. As indicated herein above, the lifetime may also be provided as a different parameter. e.g. as a percentage of total lifetime or a score. As is understood from the above, the term “factor” as relating to an aging factor or a weighted aging factor is not necessarily related to as a mathematical factor in a multiplication, although this may be the case, but rather as a factor contributing to aging calculation, which may also be, e.g., a summand, a subtrahend, or a divisor.

The term “weighted aging factor”, as used herein, relates to an aging factor adjusted to the wear a particular condition or set of conditions, in particular an aging parameter such as sample type, sample dilution, and/or sample volume, poses on a chromatography column. Thus, the weighted aging factor corresponds to an aging factor modified in dependence on the value of at least one applicable aging parameter. Thus. e.g. in case the applicable aging parameter(s) are known to cause increased wear of the chromatography column, the weighted aging factor may be higher than the aging factor. Values of aging parameters known to contribute to increased wear include e.g. high complexity of sample matrix (e.g. in a blood sample), low degree of pre-purification (e.g. direct use of a scrum sample), low sample dilution, and/or high sample volume. Conversely. e.g. in case the applicable aging parameter(s) are known to cause decreased wear of the chromatography column, the weighted aging factor may be lower than the aging factor; values of aging parameters known to contribute to decreased wear include e.g. low complexity of sample matrix (e.g. in a urine sample), high degree of pre-purification (e.g. in affinity-purified samples), high sample dilution, and/or low sample volume. As the skilled person will understand, the weighted aging factor is not necessarily based on a (theoretical) aging factor, so providing an aging factor is not necessary in all cases for providing a value of a weighted aging factor. Thus, the weighted aging factor, in an embodiment, is calculated directly from values assigned to the respective aging parameter(s), which may be experimentally be provided and stored in a database. As an example, in case the lifetime is provided as remaining runs of a chromatography column, the weighted aging factor may be >1 in case the applicable aging parameter(s) are known to cause increased wear, may be <1 in case the applicable aging parameter(s) are known to cause decreased wear, and may be about 1 in case the applicable aging parameter(s) are known to cause average wear. In an embodiment, an individual value is provided for each aging parameter. e.g. for sample matrix, for sample pre-purification state, and for sample dilution, from which a weighted aging parameter is calculated. In a further embodiment, a generic weighted aging parameter may be provided for a specific set of aging parameters, e.g. for a kind of sample used in an assay, e.g. one generic weighted aging parameter for an undiluted, non-pre-purified serum sample; in accordance, it is also envisaged that a generic weighted aging parameter is, in an embodiment, provided for an assay. Also in an embodiment, a weighted aging parameter is calculated for a specific run on a chromatography column. In a further embodiment, a summary weighted aging parameter is calculated for a number of, in a further embodiment all, preceding runs on a chromatography column.

As used herein, the term “sample”, also referred to as “test sample”, relates to any type of composition of matter; thus, the term may refer, without limitation, to any arbitrary sample such as a biological sample. In an embodiment, the sample is a liquid sample, in a further embodiment an aqueous sample. In an embodiment, the test sample is selected from the group consisting of: a physiological fluid, including whole blood, scrum, plasma, saliva, ocular lens fluid, lacrimal fluid, cerebrospinal fluid, sweat, urine, milk, ascites, mucus, synovial fluid, peritoneal fluid, and amniotic fluid: lavage fluid; tissue, cells, or the like. The sample may, however, also be a natural or industrial liquid, in particular surface or ground water, sewage, industrial wastewater, processing fluid, soil eluates, and the like. In an embodiment, the sample comprises or is suspected to comprise at least one chemical compound of interest, i.e. a chemical which shall be determined, which is referred to as “analyte”. The sample may comprise one or more further chemical compounds, which are not to be determined and which are commonly referred to as matrix, as specified herein above. The sample may be used directly as obtained from the respective source or may be subjected to one or more pretreatment and/or a sample preparation step(s). Thus, the sample may be pretreated by physical and/or chemical methods, in an embodiment by centrifugation, filtration, mixing, homogenization, chromatography, precipitation, dilution, concentration, contacting with a binding and/or detection reagent, and/or any other method deemed appropriate by the skilled person. In, i.e. before, during, and/or after, the sample preparation step, one or more internal standard(s) may be added to the sample. The sample may be spiked with the internal standard. For example, an internal standard may be added to the sample at a predefined concentration. The internal standard may be selected such that it is easily identifiable under normal operating conditions of the detector chosen. e.g. a mass spectrometry device, a photometric cell, e.g. in an UV-Vis spectroscopic device, an evaporative light scattering refractometer, a conductometer, or any device deemed appropriate by the skilled person. The concentration of the internal standard may be pre-determined and significantly higher than the concentration of the analyte.

As indicated above, the term “analyte”, as used herein, relates to any chemical compound or group of compounds which shall be determined in a sample. In an embodiment, the analyte is a macromolecule. i.e. a compound with a molecular mass of more than 1000 u (i.e. more than 1 kDa). In a further embodiment, the analyte is a biological macromolecule, in particular a polypeptide, a polynucleotide, a polysaccharide, or a fragment of any of the aforesaid. In an embodiment, the analyte is a small molecule chemical compound. i.e. a compound with a molecular mass of at most 1000 u (1 kDa). In a further embodiment, the analyte is a chemical compound metabolized by a body of a subject, in particular of a human subject, or is a compound administered to a subject in order to induce a change in the subject's metabolism. Thus, in an embodiment, the analyte is a drug of abuse or a metabolite thereof, e.g. amphetamine; cocaine; methadone; ethyl glucuronide: ethyl sulfate; an opiate, in particular buprenorphine, 6-monoacatylmorphine, codeine, dihydrocodeine, morphine, morphine-3-glucuronide, and/or tramadol; and/or an opioid, in particular acetylfentanyl, carfentanil fentanyl, hydrocodone, norfentanyl, oxycodone, and/or oxymorphone.

In an embodiment, the analyte is a therapeutic drug, e.g. valproic acid; clonazepam: methotrexate; voriconazole; mycophenolic acid (total); mycophenolic acid-glucuronide; acetaminophen; salicylic acid: theophylline; digoxin; an immuno suppressant drug, in particular cyclosporine, everolimus, sirolimus, and/or tacrolimus; an analgesic, in particular meperidine, normeperidine, tramadol, and/or O-desmethyl-tramadol: an antibiotic, in particular gentamycin, tobramycin, amikacin, vancomycin, piperacilline (tazobactam), meropenem, and/or linezolid; an antiepileptic, in particular phenytoin, valporic acid, free phenytoin, free valproic acid, levetiracetam, carbamazepine, carbamazepine-10,11-epoxide, phenobarbital, primidone, gabapentin, zonisamid, lamotrigine, and/or topiramate. In an embodiment, the analyte is a hormone, in particular cortisol, estradiol, progesterone, testosterone, 17-hydroxyprogesterone, aldosterone, dehydroepiandrosteron (DHEA), dehydroepiandrosterone sulfate (DHEA-S), dihydrotestosterone, and/or cortisone: in an embodiment, the sample is a serum or plasma sample and the analyte is cortisol. DHEA-S, estradiol, progesterone, testosterone, 17-hydroxyprogesterone, aldosterone, DHEA, dihydrotestosterone, and/or cortisone; in an embodiment, the sample is a saliva sample and the analyte is cortisol, estradiol, progesterone, testosterone, 17-hydroxyprogesterone, androstendione, and/or cortisone; in an embodiment, the sample is a urine sample and the analyte is cortisol, aldosterone, and/or cortisone. In an embodiment, the analyte is a vitamin. in an embodiment vitamin D, in particular ergocalciferol (Vitamin D2) and/or cholecalciferol (Vitamin D3) or a derivative thereof, e.g. 25-hydroxy-vitamine-D2, 25-hydroxy-vitamine-D3, 24,25-dihydroxy-vitamine-D2, 24,25-dihydroxy-vitamine-D3, 1,25-dihydroxy-vitamine-D2, and/or 1,25-dihydroxy-vitamine-D3. In a further embodiment, the analyte is a metabolite of a subject.

Operating a chromatography column comprises step (a) providing a first value of a lifetime (first lifetime value) of said chromatography column. The term “providing a first lifetime value”, as used herein, relates to any way of making available said value. In an embodiment, the first lifetime value is determined based on an initial lifetime value or a corrected initial lifetime value, as specified herein above. In an embodiment, the first lifetime value is based on, in a further embodiment is, a lifetime value valid for the chromatography column at the end of the preceding, in an embodiment immediately preceding, separation, i.e. is the preceding lifetime value. Thus, in case the chromatography column is used for a series of separations, the second lifetime value of the immediately preceding separation as specified herein may be the first lifetime value with regards to the instant separation, in a further embodiment, the initial lifetime value is provided based on the initial lifetime value as specified herein above, corrected for the cumulated lifetime effects of all or a fraction of the preceding separations; in such case, provision of the preceding lifetime value may not be necessary. In an embodiment, the first lifetime value of the column is based on an initial value of said lifetime and the weighted aging factors of any preceding uses of said chromatography column. In an embodiment, in case an initial lifetime value and a preceding lifetime value are not available, an estimated first lifetime value may be provided based on e.g. one or more performance parameters of the chromatography column, preferably as specified herein below.

Operating a chromatography column further comprises step (b) performing a chromatographic separation of a sample on said chromatography column. In an embodiment, said step comprises applying a sample and at least one column void volume, in a further embodiment at least one column volume, of mobile phase onto said chromatography column. The step may further comprise applying further mobile phase, a mobile phase gradient and/or applying steps of re-equilibration to the chromatography column. Also, the step may include detection of one or more analyte(s) after separation by means known to the skilled person, and/or collection of one or more fraction(s) for further analysis. The step may also comprise performing mass spectrometry on at least part of the eluate from the chromatography column.

Operating a chromatography column further comprises step (c) providing a value of a weighted aging factor calculated based on at least one aging parameter selected from sample type, sample dilution, and sample volume. The terms aging parameter and weighted aging factor are specified herein above. In an embodiment, the value of a weighted aging factor is calculated based on aging parameters comprising sample type, sample dilution, and sample volume; in a further embodiment, the value of a weighted aging factor is calculated based on aging parameters comprising sample type, sample dilution, sample volume, and set of chromatography conditions applied. In an embodiment, the aging parameters are combined into a single, assay-specific weighted aging factor. As indicated above, the aging parameter may be quantifiable and have a value as such, or may have an assigned aging parameter factor value. Thus, calculating a weighted aging factor, in an embodiment, comprises providing a value of an aging parameter or of an aging parameter factor assigned thereto. e.g., in an embodiment, from a database. Based on the numerical value of the aging parameter or the aging parameter factor assigned thereto, a weighted aging factor can be calculated in principle by any means deemed appropriate by the skilled person; thus, from the information provided herein, the skilled person is enabled to calculate a weighted aging factor as deemed appropriate. In an exemplary embodiment, the aging parameters sample type, sample dilution, and sample volume are determined. In such case, the weighted aging factor (F) for one separation may be calculated according to eq. (1):

F=T×D×V (1)

with T=sample type aging parameter: D sample dilution aging parameter; and V=sample volume aging parameter. Also, the weighted aging factor (F) for several separations may be calculated according to eq. (2):

$$F = {\sum }_{i = 1}^{n} ( {T}_{i} \times {D}_{i} \times {V}_{i} ) \qquad ( 2 )$$

with Ti=sample type aging parameter of chromatographic separation i; Di=sample dilution aging parameter of chromatographic separation i; Vi=sample volume aging parameter of chromatographic separation i: and n=total number of chromatographic separations performed on the chromatography column. As the skilled person understands, the aging parameter factor values assigned to aging parameters may, e.g., in an embodiment, also be expressed as fraction of total lifetime; thus, in such case the weighted aging factor may be calculated as the sum of the values of the respective aging parameters.

In view of the above, the present invention relates to a method for operating a chromatography column comprising

(a) providing a first value of a lifetime (first lifetime value) of said column;

(b) performing a chromatographic separation of a sample on said chromatography column;

(c) providing a value of a weighted aging factor determined based on at least one sample specific aging parameter selected from sample type, sample dilution, and sample volume; and on at least one operation specific aging parameter, and

(d) determining a second value of said lifetime (second lifetime value) of said chromatography column based on said first lifetime value and said weighted aging factor.

In an embodiment, operating a chromatography column further comprises step (c) providing a value of a weighted aging factor calculated based on at least one aging parameter selected from sample type, sample dilution, and sample volume and on at least one operation specific aging parameter. The terms aging parameter and weighted aging factor are specified herein above. In an embodiment, the value of a weighted aging factor is calculated based on sample specific aging parameters comprising sample type, sample dilution, and sample volume and on operation specific aging parameters comprising eluent pH, pressure conditions, and a parameter indicative a solvent exchange; in a further embodiment, the value of a weighted aging factor is calculated based on aging parameters comprising sample type, sample dilution, sample volume, and set of chromatography conditions applied. In an embodiment, the sample specific aging parameters and the assay specific aging parameters are combined into a single, assay-specific weighted aging factor. As indicated above, the aging parameter may be quantifiable and have a value as such, or may have an assigned aging parameter factor value. Thus, calculating a weighted aging factor, in an embodiment, comprises providing a value of an aging parameter or of an aging parameter factor assigned thereto, e.g., in an embodiment, from a database. Based on the numerical value of the aging parameter or the aging parameter factor assigned thereto, a weighted aging factor can be calculated in principle by any means deemed appropriate by the skilled person: thus, from the information provided herein, the skilled person is enabled to calculate a weighted aging factor as deemed appropriate. In an exemplary embodiment, the aging parameters sample type, sample dilution, and sample volume are determined. In such case, the weighted aging factor (F) for one separation may be calculated according to eq. (10):

F=T×D×V×E×P×S (10)

with T=sample type aging parameter: D=sample dilution aging parameter; and V=sample volume aging parameter; E=eluent pH aging parameter; P=pressure conditions aging parameter: S=Solvent exchange aging parameter. Also, the weighted aging factor (F) for several separations may be calculated according to eq. (11):

$$F = {\sum }_{i = 1}^{n} ( {T}_{i} \times {D}_{i} \times {V}_{i} \times {E}_{i} \times {P}_{i} \times {S}_{i} )$$

with Tᵢ=sample type aging parameter of chromatographic separation i; I=sample dilution aging parameter of chromatographic separation i: V; =sample volume aging parameter of chromatographic separation i; Eᵢ=eluent pH aging parameter of chromatographic separation 1; P, =pressure conditions aging parameter of chromatographic separation i; Sᵢ=solvent exchange aging parameter of chromatographic separation i and n=total number of chromatographic separations performed on the chromatography column. As the skilled person understands, the aging parameter factor values assigned to aging parameters may, e.g., in an embodiment, also be expressed as fraction of total lifetime: thus, in such case the weighted aging factor may be calculated as the sum of the values of the respective aging parameters.

Operating a chromatography column further comprises step (d) determining a second value of said lifetime (second lifetime value) of said chromatography column based on said first lifetime value and said weighted aging factor. Determining of a second lifetime value may, in principle, be accomplished by any method deemed appropriate by the skilled person and a method is selected in particular depending on the form in which the first lifetime value and the weighted aging factor are provided. Thus, in case the first lifetime value is a remaining lifetime value, the weighted aging factor will typically be applied such that a separation causing a decrease of chromatography column lifetime causes the second lifetime value to be lower than the first lifetime value. In an exemplary embodiment, the second lifetime value (R_{L}) is calculated according to eq. (3):

R_{L}=R_{L-1}−F (3)

with R_{L-1}=first lifetime value; and F=weighted aging factor.

Conversely, in case the first lifetime value is a spent lifetime value, the weighted aging factor will typically be applied such that a separation causing a decrease of chromatography column lifetime causes the second lifetime value to be higher than the first lifetime value. Thus, in a further exemplary embodiment, the second lifetime value (R_{L}) is calculated according to eq. (4);

R_{L}=R_{L-1}+F (4)

with R_{L-1}=first lifetime value; and F=weighted aging factor.

In a further exemplary embodiment, determining a second lifetime value may also be based on an initial lifetime value (R₀) and a cumulated weighted aging factor, thus, in case a remaining lifetime shall be determined based on the initial lifetime, the calculation may be according to eq. (5):

$${R}_{L} = {R}_{0} - {\sum }_{i = 1}^{n} {F}_{i} \qquad ( 5 )$$

with Fᵢ=weighted aging factor of chromatographic separation i; and n=total number of chromatographic separations performed on the chromatography column. Thus, a second lifetime value may be provided as remaining lifetime according to eq. (6)

$${R}_{L} = {R}_{0} - {\sum }_{i = 1}^{n} ( {T}_{i} \times {D}_{i} \times {V}_{i} ) \qquad ( 6 )$$

with definitions as above.

In the converse, in case a spent lifetime over a number of separations shall be determined, this may be calculated according to eq. (7)

$${R}_{L} = {R}_{0} + {\sum }_{i = 1}^{n} {F}_{i} \qquad ( 7 )$$

or eq. (8)

$${R}_{L} = {R}_{0} + {\sum }_{i = 1}^{n} ( {T}_{i} \times {D}_{i} \times {V}_{i} ) \qquad ( 8 )$$

with the above definitions. As the skilled person understands, in the case a spent lifetime over the whole use of a chromatography column shall be determined. R₀ may be 0.

Optionally, determining the second lifetime value in step b) is further based on at least one of (i) a parameter indicating the initial performance of said chromatography column, in an embodiment determined upon release testing: (ii) a parameter indicating the performance requirement of the assay of interest: (iii) a parameter indicating current performance of said chromatography column: and (iv) a parameter indicating onboard aging, in an embodiment time and/or temperature of column keeping.

As used herein, the term “parameter indicating the initial performance” of a chromatography column includes all measurable parameters correlating with initial column performance, i.e. column performance before the first separation is performed. In accordance, the parameter indicating the initial performance is determined before the first separation is performed, in an embodiment upon release testing. Suitable parameters are in particular performance parameters as specified herein above. As the skilled person understands, there is some individual variability in performance even among newly manufactured columns of the same type; in accordance, including a parameter indicating the individual initial performance of a chromatography column in determining the second lifetime value compensates for this initial variability. The parameter indicating the initial performance may also be used to correct the initial lifetime value, e.g. the initial lifetime value provided by the manufacturer of the chromatography column.

The term “parameter indicating the performance requirement” of the assay of interest relates to a parameter correlating with the performance requirements of a particular assay. As indicated herein above, different assays may have different requirements for chromatography column performance. As also indicated herein above, said requirements may be reflected by the definition of an assay-specific reference; as an alternative or in addition, said requirements may also be reflected by including a parameter indicating the performance requirement into the determination of a second lifetime value. Thus, in case e.g. a remaining lifetime is provided, the parameter indicating the performance requirement of an assay may be selected to reduce the value of the resulting second lifetime value in case an assay requiring high performance is used. Thus, in an embodiment, said parameter indicating the performance requirement is the parameter of the planned following assay.

The term “parameter indicating current performance of said chromatography column” is understood by the skilled person and includes in particular the performance parameters as specified herein above. The parameter indicating current performance is, in an embodiment, determined after at least one separation has been performed on the chromatography column, in a further embodiment is determined during and/or after the immediately preceding and/or the current separation.

As used herein, the term “parameter indicating onboard aging” includes any parameter correlating with column aging independent of separations performed on said chromatography column. Thus, the term in particular relates to environmental factors having an impact on column shelf life in an embodiment time and/or temperature of column keeping.

In accordance with the above in an embodiment, in case a remaining lifetime value is provided, the second lifetime value of a column for an assay of interest is calculated according to eq. (9)

$${R}_{L} = {R}_{0} \times γ \times β \times δ - {\sum }_{i = 1}^{n} ( {T}_{i} \times {D}_{i} \times {V}_{i} ) - ε ( {t}_{n} - {t}_{0} ) \qquad ( 9 )$$

with definitions as above and additional definitions being. γ=parameter indicating the initial performance of the chromatography column, β=parameter indicating the performance requirement of the assay of interest; δ=parameter indicating current performance of the chromatography column; ε=parameter indicating onboard aging; tₙ=time point of determining the second lifetime value; and t₀=time point of start of column use.

Optionally, operating a chromatography column further comprises step (e) comparing said second lifetime value to a reference. The term “reference”, as used herein, relates to a lifetime value pre-determined or assumed to represent a lifetime value ensuring that the chromatography column is still suitable for a given assay. Thus, the reference, in an embodiment, is a threshold value or a range for which it is assumed or has been determined that performance of the chromatography column is sufficient to achieve the purpose of the assay, in an embodiment fulfilling applicable quality criteria. In accordance, a use of the chromatography column may be discontinued or modified based on the result of comparing step (e). In an embodiment, use of said chromatography column is discontinued or modified in case the second lifetime value is outside a pre-defined reference range or is beyond a reference threshold. In an exemplary embodiment, in case the lifetime value is provided as a remaining lifetime value, the use of the chromatography column is discontinued or modified in case the second lifetime value is found to be lower than a reference value, e.g. a pre-determined threshold value, or outside a pre-determined reference range.

Based on the result of step c), use of said chromatography column may be continued, discontinued, or modified. As is understood from the above, in case the comparison of step e) indicates that the chromatography column is still suitable to achieve the purpose of the assay, use of the chromatography column in said assay may be continued. In case the comparison of step c) indicates that the chromatography column is no longer suitable to achieve the purpose of the assay, use of the chromatography column in said assay may be discontinued or the use of the chromatography column may be modified. Modifications of chromatography column use, in an embodiment, comprises measures to improve column performance, e.g. comprises repacking said chromatography column or application of cleaning in place measures: as will be understood by the skilled person, measures to improve column performance may have an impact on the value of column lifetime; e.g. in case the lifetime value is provided as a remaining lifetime value, the remaining lifetime value may increase by such measures. In a further embodiment, modification of column use comprises reserving said chromatography column for applications in which lower performance is required. Thus, the reference as specified herein, in an embodiment, is an assay-specific value.

In an embodiment, the method for operating a chromatography column is a predictive method and/or, in an embodiment, the aging parameter values am pre-determined. Thus, in an embodiment, the method may be performed completely during routine operation of a column and in particular does not require supplementary runs in the absence of a sample or runs with a marker compound to determine chromatography column lifetime. Thus, with the method of the present invention, in an embodiment it can advantageously be avoided having to intersperse control runs for ensuring column performance between analytical runs. It may, however, be envisaged to intersperse such control runs to establish a new first value of a column lifetime after e.g. every 100^{th} run.

In an embodiment, the method for operating a chromatography column is part of a method for predicting end of usability of a chromatography column, which may comprise performing the method for operating a chromatography column as specified herein at least twice, in an embodiment using the second lifetime value determined after the first performing the method as the first lifetime value for the second performing of the method. As the skilled person understands, the aforesaid proceeding may be performed several times, thus providing e.g. a series of decreasing remaining lifetime values over the number of chromatographic separations, thus allowing extrapolation to a reference lifetime value by standard mathematical means.

Advantageously, it was found in the work underlying the present invention that operation of a chromatography column can be improved by the proceeding as specified herein; in particular, column performance can be better predicted by the use of weighted aging factors. Also, quality control requirements can be better fulfilled by the method described herein. The definitions made above apply mutatis mutandis to the following. Additional definitions and explanations made further below also apply for all embodiments described in this specification mutatis mutandis.

The present invention also relates to a method for operating a chromatography column comprising

(a) providing an initial value of a lifetime (initial lifetime value) of said chromatography column;

(b) performing a chromatographic separation of a sample on said chromatography column:

(c) providing a value of a parameter indicating the initial performance of said chromatography column based on the chromatographic separation of step b); and

(d) determining a corrected initial value of said initial lifetime (corrected initial lifetime value) of said chromatography column based on said initial lifetime value and said parameter indicating the initial performance of said chromatography column.

The present invention also relates to a method for operating a chromatography column comprising

(a) providing a first value of a lifetime (first lifetime value) of said chromatography column:

(b) providing a value of a parameter indicating the performance requirement of an assay of interest; and

(c) determining a second value of said lifetime (second lifetime value) of said chromatography column based on said first lifetime value and said value of the parameter indicating the performance requirement of an assay of interest.

The present invention also relates to a method for operating a chromatography column comprising

(a) providing a first value of a lifetime (first lifetime value) of said chromatography column;

(b) performing a chromatographic separation of a sample on said chromatography column:

(c) providing a value of a parameter indicating current performance of said chromatography column based on the chromatographic separation of step b); and

(d) determining a second value of said lifetime (second lifetime value) of said chromatography column based on said first lifetime value and said value of the parameter indicating current performance of said chromatography column.

The present invention also relates to a method for operating a chromatography column comprising

(a) providing a first value of a lifetime (first lifetime value) of said chromatography column;

(b) providing a value of a parameter indicating onboard aging; and

(c) determining a second value of said lifetime (second lifetime value) of said chromatography column based on said first lifetime value and said value of a parameter indicating onboard aging.

As indicated herein above, a generic weighted aging factor may be provided for an assay. As the skilled person will understand, such a generic weighted aging factor may be provided by a method comprising the steps of

(I) determining at least one first value of a performance parameter of the chromatography column;

(II) performing at least one, preferably a multitude of, chromatographic separation(s) under conditions of an assay;

(III) determining at least one second value of said performance parameter; and

(IV) based on said first and second performance parameters, or values derived therefrom; determining a value of a generic weighted aging parameter for said assay.

The present invention further relates to a method of establishing a data collection of annotated aging parameter categories and aging parameter factors, preferably tangibly embedded on a storage medium, of aging parameter values for a chromatography column comprising

(I) determining at least one first value of a performance parameter of the chromatography column;

(II) performing at least one, preferably a multitude of, chromatographic separation(s) under conditions of a first set of aging parameter category values;

(III) determining at least one second value of said performance parameter:

(IV) performing at least one, preferably a multitude of, chromatographic separation(s) under conditions of a second set of aging parameter category values; wherein said second set of aging parameter category values is non-identical to said first set of aging parameter category values;

(V) determining at least one third value of said performance parameter; and

(VI) based on said first, second, and third performance parameters, or values derived therefrom; and said first and second set of aging parameter category values, or values derived therefrom, determining a value of an aging parameter factor for at least one aging parameter category and annotating the values of said at least one aging parameter category and said aging parameter factor into a data collection.

The aforesaid method of establishing a data collection of the present invention may comprise further steps. e.g. determining further values of a performance parameter under conditions of a further sets of aging parameter category values non-identical to the first and second sets of aging parameter category values. Also one or more, in an embodiment all, steps are assisted or performed by automated equipment. Further, the method may comprise determining at least one analyte, i.e. the method may be an in-line method performed concomitantly to performing a chromatographic assay on the chromatography column. Thus, in an embodiment, the method may further comprise collecting values of performance parameters during use of at least one analytical system making use of a chromatography column. In an embodiment, the method further comprises collecting said information over a multitude of analytical systems. In an embodiment, the values of the data collection established as specified above are considered applicable to all chromatography columns of a particular lot, in a further embodiment all chromatography columns of a particular column configuration (as may be represented by e.g. a manufacturer and an order number or type designation), in a further embodiment all chromatography columns of a particular column type. In accordance, the method of establishing a data collection may be performed on more than one chromatography column; as the skilled person will understand, step (III) may have to be performed for each column in such case. Thus, in an embodiment, steps (I) to (II) may be performed on a first chromatography column or set of chromatography columns, and steps (III) to (V) may be performed on a second chromatography column or set of chromatography columns. In an embodiment said first and second chromatography columns are from the same lot, the same column configuration and/or the same column type in such case.

The terms “aging parameter”, “aging parameter category”, and “aging parameter factor” have been specified herein above. As the skilled person will understand in view of the instant description, assigning an aging parameter factor value to an aging parameter category value is hampered by the fact that in each chromatographic separation a set of values of aging parameter categories is applied to a chromatography column. Thus, in order to determine the contribution of a single aging parameter category, the impact on column performance is compared for two sets of aging factor categories, in which only the aging parameter category of interest was varied. Thus, in an embodiment, the second set of aging parameter category values differs from said first set of aging parameter category values in one aging parameter category value. There may, however, also be cases in which the impact of a variation of a multitude of aging parameter categories is or interest, e.g. in case the sample is switched from a low-volume serum sample to a high-volume urine sample; in such case, in an embodiment, the second set of aging parameter category values differs from said first set of aging parameter category values in a multitude of aging parameter category value.

In an embodiment, the method optionally comprises further step (VII) comparing the difference between the third and the second value of the performance parameter to the difference between the second and the first value of the performance parameter, and, based on said comparison, determining a value of the aging parameter factor(s) non-identical between the first and the second set of aging parameter values.

The term “data collection” refers to a collection of data which may be physically and/or logically grouped together. Accordingly, the data collection may be implemented in a single storage medium or in physically separated storage media being operatively linked to each other. In an embodiment, the data collection is implemented by means of a database. Thus, a database as used herein comprises the data collection on a suitable storage medium. Moreover, the database, in an embodiment, further comprises a database management system. The database management system is, in an embodiment, a network-based, hierarchical or object-oriented database management system. Furthermore, the database may be a federal or integrated database. In a further embodiment, the database will be implemented as a distributed (federal) system, e.g. as a Client-Server-System. In a further embodiment, the database is structured as to allow a search algorithm to compare a test data set with the data sets comprised by the data collection. Specifically, by using such an algorithm, the database can be searched for similar or identical data sets being indicative for a medical condition or effect as set forth above (e.g. a query search). Thus, if an identical or similar data set can be identified in the data collection, the test data set will be associated with the said medical condition or effect. Consequently, the information obtained from the data collection can be used. e.g., as a reference for the methods of the present invention described above.

The term “storage medium” as used herein encompasses data storage media which are based on single physical entities such as a CD, a CD-ROM, a hard disk, optical storage media, or a diskette. Moreover, the term further includes data storage media consisting of physically separated entities which are operatively linked to each other in a manner as to provide the aforementioned data collection, in an embodiment, in a suitable way for a query search.

The present invention also relates to a data collection, in an embodiment tangibly embedded on a storage medium, comprising at least one generic weighted aging factor determined according to the method according to the method of determining a generic weighted aging factor and/or comprising at least one set of an aging parameter factor value annotated to an aging parameter category value, and, optionally, to a chromatographic protocol, wherein said aging parameter category value comprises at least one category value of an aging parameter selected from sample type, sample dilution, and sample volume, in an embodiment wherein said values were obtained according to the method according to the method of establishing a data collection of annotated aging parameter categories and aging parameter factors described herein.

In view of the above, the data collection, in an embodiment, further comprises at least one, in an embodiment at least two, in a further embodiment at least three, in a further embodiment all, of (i) a parameter indicating the initial performance of a chromatography column; (ii) a parameter indicating the performance requirement of an assay of interest assay; (iii) a parameter indicating current performance of a chromatography column: and (iv) a parameter indicating onboard aging. Also, the database may further comprise one or more reference values.

The present invention also relates to a device for determining a second lifetime value of a chromatography column, comprising

(a) a storage medium comprising tangibly embedded a data collection, said data collection comprising at least one set of an aging parameter factor value annotated to an aging parameter category value, and, optionally, to a chromatographic protocol, wherein said aging parameter category value comprises at least one category value of an aging parameter selected from sample type, sample dilution, and sample volume: and a data collection tangibly embedded on a storage medium, comprising a first lifetime value of said chromatography column and/or an initial lifetime value of said chromatography column.

(b) an input unit configured for receiving input data indicative of at least one aging parameter factor value; and

(c) a data processing unit, wherein said data processing unit is Configured to calculate a second lifetime value of said chromatography column based on said input data indicative of at least one aging parameter factor value, said first lifetime value of said chromatography column and/or said initial lifetime value.

The term “device”, as used herein, relates to a collection of means which are operatively linked to each other to provide the indicated function. Said means may be implemented in a single physical unit or in physically separated units which are operatively linked to each other. Suitable components and their properties are described elsewhere herein below and also herein above in the context of the methods. Consequently, one or more methods of the present invention can be implemented by the device specified herein. Thus, in an embodiment, the device is configured to perform at least one method as specified elsewhere herein. The device may comprise further units, in particular an output unit, a communication interface, and/or any other units deemed appropriate by the skilled person.

The term “input unit”, as used herein, relates to any arbitrary unit configured for a transfer of information from another entity to the device, in particular its data processing unit or a data storage medium, wherein another entity may be a further data processing device or a user. Thus, the input unit may comprise a user interface; the input unit may, however, also be a storage medium comprising a data collection, from which appropriate values may be retrieved. The input unit may, however, also be an interface to an analysis unit measuring at least one input data indicative of an aging parameter factor value.

The term “input data indicative of at least one aging parameter factor value” includes all data from which an aging parameter factor value can be derived, e.g. by calculation or by retrieval from a data collection. Thus, the input data indicative of at least one aging parameter factor value may in particular be a value of a performance parameter, of an aging parameter category, and/or an aging parameter factor per se, in an embodiment is a value of an aging parameter category.

The term “data processing unit” generally refers to an arbitrary unit adapted to perform the method step(s) as described above, in an embodiment by using at least one processor and/or at least one application-specific integrated circuit. Thus, as an example, the at least one data processing unit may comprise a software code stored thereon comprising a number of computer instructions. The data processing unit may provide one or more hardware elements for performing one or more of the indicated operations and/or may provide one or more processors with software running thereon for performing one or more of the method steps.

The term “output unit”, as used herein, relates to any arbitrary unit configured for a transfer of information from the system to another entity, wherein another entity may be a further data processing device and/or a user. Thus, the output device may comprise a user interface, such as an appropriately configured display, or may be a printer. The output unit may, however also be an indicator. e.g. an indicator lamp, indicating that the second lifetime value is beyond a pre-determined reference.

The term “communication interface” is understood by the skilled person to relate to any arbitrary interface configured for exchange of information, in particular exchange of data.

Such data exchange may be achieved by a permanent or temporary physical connection, such as coaxial, fiber, fiber-optic or twisted-pair, 10 BASE-T cables, storage unit connectors, such as USB, firewire, and similar connectors. Alternatively, it may be achieved by a temporary or permanent wireless connection using. e.g., radio waves, such as Wi-Fi. LTE, LTE-advanced or Bluetooth.

The instant invention also relates to a system comprising a chromatography column and a device of the present invention.

Also, the present invention relates to a use of a weighted aging factor for determining the lifetime of a chromatography column.

The invention further discloses and proposes a computer program including computer-executable instructions for performing a method according to the present invention in one or more of the embodiments enclosed herein when the program is executed on a computer or computer network. Specifically, the computer program may be stored on a computer-readable data carrier. Thus, specifically, one, more than one or even all of the method steps as indicated above may be performed by using a computer or a computer network, preferably by using a computer program.

The invention further discloses and proposes a computer program product having program code means, in order to perform a method according to the present invention in one or more of the embodiments enclosed herein when the program is executed on a computer or computer network. Specifically, the program code means may be stored on a computer-readable data carrier.

Further, the invention discloses and proposes a data carrier having a data structure stored thereon, which, after loading into a computer or computer network, such as into a working memory or main memory of the computer or computer network, may execute a method according to one or more of the embodiments disclosed herein.

The invention further proposes and discloses a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier. Specifically, the computer program product may be distributed over a data network.

Finally, the invention proposes and discloses a modulated data signal which contains instructions readable by a computer system or computer network, for performing the method according to one or more of the embodiments disclosed herein.

In an embodiment, referring to the computer-implemented aspects of the invention, one or more of the method steps or even all of the method steps of a method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, the present invention further discloses:

A computer or computer network comprising at least one processor, wherein the processor is adapted to perform the method according to one of the embodiments described in this description,

a computer loadable data structure that is adapted to perform the method according to one of the embodiments described in this description while the data structure is being executed on a computer,

a computer program, wherein the computer program is adapted to perform the method according to one of the embodiments described in this description while the program is being executed on a computer,

a computer program comprising program means for performing the method according to one of the embodiments described in this description while the computer program is being executed on a computer or on a computer network,

a computer program comprising program means according to the preceding embodiment, wherein the program means are stored on a storage medium readable to a computer,

a storage medium, wherein a data structure is stored on the storage medium and wherein the data structure is adapted to perform the method according to one of the embodiments described in this description after having been loaded into a main and/or working storage of a computer or of a computer network, and

a computer program product having program code means, wherein the program code means can be stored or are stored on a storage medium, for performing the method according to one of the embodiments described in this description, if the program code means are executed on a computer or on a computer network.

In view of the above, the following embodiments are particularly envisaged:

1. A Method for Operating a Chromatography Column Comprising

(a) providing a first value of a lifetime (first lifetime value) of said chromatography column;

(b) performing a chromatographic separation of a sample on said chromatography column:

(c) providing a value of a weighted aging factor determined based on at least one aging parameter selected from sample type, sample dilution, and sample volume; and

(d) determining a second value of said lifetime (second lifetime value) of said chromatography column based on said first lifetime value and said weighted aging factor.

2. The method of embodiment 1, wherein said sample type is defined by sample matrix and/or pre-purification state of said sample.

3. The method of embodiment 1 or 2, wherein said value of a weighted aging factor is calculated based on at least one further aging parameter selected from time since a preceding use, storage conditions since a preceding use, and set of chromatography conditions applied.

4. The method of any one of embodiments 1 to 3, wherein said value of a weighted aging factor is calculated based on aging parameters comprising sample type, sample dilution, and sample volume.

5. The method of any one of embodiments 1 to 4, wherein said value of a weighted aging factor is calculated based on aging parameters comprising sample type, sample dilution, sample volume, and set of chromatography conditions applied.

6. The method of any one of embodiments 1 to 5, wherein said aging parameters are combined into a single, assay-specific weighted aging factor.

7. The method of any one of embodiments 1 to 6, wherein said method further comprises step (e) comparing said second lifetime value to a reference.

8. The method of embodiment 7, wherein a use of said chromatography column is discontinued or modified based on the result of said comparing step (e).

9 The method of embodiment 8, wherein use of said chromatography column is discontinued or modified in case said second lifetime value is outside a pre-defined reference range or is beyond a reference threshold.

10. The method of embodiment 8 or 9, wherein said modified use comprises repacking said chromatography column and/or reserving said chromatography column for applications in which lower performance is required.

11. The method of any one of embodiments 1 to 10, wherein said weighted aging factor is calculated according to equation (1):

F=T×D×V (1)

with F=weighted aging factor.

T=sample type aging parameter;

D=sample dilution aging parameter; and

V=sample volume aging parameter.

12. The method of any one of embodiments 1 to 11, wherein said second lifetime value is calculated according to equation (3):

R_{L}=R_{L-1}−F (3)

with R_{L}=second lifetime value;

R_{L-1}=first lifetime value; and

F=weighted aging factor, preferably calculated according to embodiment 11.

13. The method of any one of embodiments 1 to 11, wherein said second lifetime value is calculated according to equation (4):

R_{L}=R_{L-1}+F (4)

with R_{L}=second lifetime value:

R_{L-1}=first lifetime value; and

F=weighted aging factor, preferably calculated according to embodiment 11.

14. The method of any one of embodiments 1 to 13, wherein providing said first lifetime value of said column is based on an initial value of said lifetime (initial lifetime value) and the weighted aging factors of any preceding uses of said chromatography column.

15. The method of embodiment 14, wherein said initial lifetime value is a column type specific value.

16. The method of any one of embodiments 1 to 15, wherein determining the second lifetime value in step b) is further based on at least one of

(i) a parameter indicating the initial performance of said chromatography column, in an embodiment determined upon release testing;

(ii) a parameter indicating the performance requirement of the assay used;

(iii) a parameter indicating current performance of said chromatography column; and

(iv) a parameter indicating onboard aging, in an embodiment time and/or temperature of column keeping.

17. The method of embodiment 16, wherein in (i) and/or (iii) the parameter indicating performance is selected from retention time, peak width, peak symmetry, resolution, break-through point, and column pressure.

18. The method of any one of embodiments 1 to 17, wherein a multitude of chromatographic separations is performed on said chromatography column, wherein said first lifetime value is an initial lifetime value, and wherein said second lifetime value is a remaining lifetime value calculated according to equation (6)

$${R}_{L} = {R}_{0} - {\sum }_{i = 1}^{n} ( {T}_{i} \times {D}_{i} \times {V}_{i} ) \qquad ( 6 )$$

with R_{L}=second lifetime value;

R₀=initial lifetime value

Tᵢ=sample type aging parameter of chromatographic separation i:

Dᵢ=sample dilution aging parameter of chromatographic separation i:

Vᵢ=sample volume aging parameter of chromatographic separation i; and

n=total number of chromatographic separations performed on the chromatography column.

19. The method of any one of embodiments 1 to 19, wherein a multitude of chromatographic separations is performed on said chromatography column and wherein said second lifetime value is a spent lifetime value calculated according to equation (8)

$${R}_{L} = {R}_{0} + {\sum }_{i = 1}^{n} ( {T}_{i} \times {D}_{i} \times {V}_{i} ) \qquad ( 8 )$$

with R_{L}=second lifetime value;

R₀=initial lifetime value

Tᵢ=sample type aging parameter of chromatographic separation i;

Dᵢ=sample dilution aging parameter of chromatographic separation i;

Vᵢ=sample volume aging parameter of chromatographic separation i; and

n=total number of chromatographic separations performed on the chromatography column.

20. The method of any one of embodiments 1 to 19, wherein said second lifetime value is the current lifetime value.

21. A method of establishing a data collection of annotated aging parameter categories and aging parameter factors, preferably tangibly embedded on a storage medium, for a chromatography column comprising

(I) determining at least one first value of a performance parameter of the chromatography column;

(II) performing at least one, in an embodiment a multitude of, chromatographic separation(s) under conditions of a first set of aging parameter category values;

(III) determining at least one second value of said performance parameter;

(IV) performing at least one, in an embodiment a multitude of, chromatographic separation(s) under conditions of a second set of aging parameter category values; wherein said second set of aging parameter category values is non-identical to said first set of aging parameter category values;

(V) determining at least one third value of said performance parameter; and

(VI) based on said first, second, and third performance parameters, or values derived therefrom; and said first and second set of aging parameter category values, or values derived therefrom, determining a value of an aging parameter factor for at, least one aging parameter category and annotating the values of said at least one aging parameter category and said aging parameter factor into a data collection.

22. The method of embodiment 21, wherein said second set of aging parameter category values differs from said first set of aging parameter category values in one aging parameter category value.

23. The method of embodiment 21 or 22, wherein said method comprises further step (VII) comparing the difference between the third and the second value of the performance parameter to the difference between the second and the first value of the performance parameter, and, based on said comparison, determining a value of the aging parameter factor(s) non-identical between the first and the second set of aging parameter values.

24. A data collection, in an embodiment tangibly embedded on a storage medium, comprising at least one set of an aging parameter factor value annotated to an aging parameter category value, and, optionally, to a chromatographic protocol, wherein said aging parameter category value comprises at least one category value of an aging parameter selected from sample type, sample dilution, and sample volume and/or comprising at least one generic weighted aging factor determined according to the method according embodiment 32.

25. A device for determining a second lifetime value of a chromatography column, comprising

(a) a storage medium comprising tangibly embedded a data collection, said data collection comprising at least one set of an aging parameter factor value annotated to an aging parameter category value, and, optionally, to a chromatographic protocol, wherein said aging parameter category value comprises at least one category value of an aging parameter selected from sample type, sample dilution, and sample volume; and a data collection tangibly embedded on a storage medium, comprising a first lifetime value of said chromatography column and/or an initial lifetime value of said chromatography column.

(b) an input unit configured for receiving input data indicative of at least one aging parameter factor value: and

(c) a data processing unit, wherein said data processing unit is configured to calculate a second lifetime value of said chromatography column based on said input data indicative of at least one aging parameter factor value, said first lifetime value of said chromatography column and/or said initial lifetime value.

26. A system comprising a chromatography column and a device according to embodiment 25.

27. Use of a weighted aging factor for determining the lifetime of a chromatography column.

28. A method for operating a chromatography column comprising

(a) providing an initial value of a lifetime (initial lifetime value) of said chromatography column;

(b) performing a chromatographic separation of a sample on said chromatography column;

(c) providing a value of a parameter indicating the initial performance of said chromatography column based on the chromatographic separation of step b) and

(d) determining a corrected initial value of said initial lifetime (corrected initial lifetime value) of said chromatography column based on said initial lifetime value and said parameter indicating the initial performance of said chromatography column.

29. The present invention also relates to a method for operating a chromatography column comprising

(a) providing a first value of a lifetime (first lifetime value) of said chromatography column:

(b) providing a value of a parameter indicating the performance requirement of an assay of interest; and

(c) determining a second value of said lifetime (second lifetime value) of said chromatography column based on said first lifetime value and said value of the parameter indicating the performance requirement of an assay of interest.

30. The present invention also relates to a method for operating a chromatography column comprising

(a) providing a first value of a lifetime (first lifetime value) of said chromatography column:

(b) performing a chromatographic separation of a sample on said chromatography column;

(c) providing a value of a parameter indicating current performance of said chromatography column based on the chromatographic separation of step b) and

(d) determining a second value of said lifetime (second lifetime value) of said chromatography column based on said first lifetime value and said value of the parameter indicating current performance of said chromatography column.

31. The present invention also relates to a method for operating a chromatography column comprising

(a) providing a first value of a lifetime (first lifetime value) of said chromatography column;

(b) providing a value of a parameter indicating onboard aging: and

(c) determining a second value of said lifetime (second lifetime value) of said chromatography column based on said first lifetime value and said value of a parameter indicating onboard aging.

32. A method for determining a generic weighted aging factor for a chromatographic assay comprising the steps of

(I) determining at least one first value of a performance parameter of the chromatography column:

(II) performing at least one, preferably a multitude of, chromatographic separation(s) under conditions of an assay;

(III) determining at least one second value of said performance parameter: and

(IV) based on said first and second performance parameters, or values derived therefrom; determining a value of a generic weight aging parameter factor for said chromatographic assay.

33. The subject matter of any one of embodiments 21 to 32 further comprising the subject matter of any one of embodiments 1 to 20.

34. The method of any one of embodiments 1 to 20, wherein step (c) is providing a value of a weighted aging factor determined based on at least one sample specific aging parameter selected from sample type, sample dilution, and sample volume: and on at least one operation specific aging parameter.

35. The method of embodiment 34, wherein said operation specific aging parameter is an assay specific parameter, a time since a preceding use, storage conditions since a preceding use, and/or a parameter indicative of a solvent exchange.

36. The method of embodiment 35, wherein said assay specific aging parameter is an eluent pH and/or pressure conditions.

37. The method of embodiment 36, wherein the weighted aging factor (F) for one separation is calculated according to eq. (10):

F=T×D×V×E×P×S (10)

with T=sample type aging parameter; D=sample dilution aging parameter; and V=sample volume aging parameter: E=eluent pH aging parameter; P=pressure conditions aging parameter: S=Solvent exchange aging parameter.

38. The method of embodiment 36, wherein a multitude of chromatographic separations is performed on said chromatography column and wherein the weighted aging factor (F) is calculated according to eq. (11):

$$F = {\sum }_{i = 1}^{n} ( {T}_{i} \times {D}_{i} \times {V}_{i} \times {E}_{i} \times {P}_{i} \times {S}_{i} )$$

with Tᵢ=sample type aging parameter of chromatographic separation i; Dᵢ=sample dilution aging parameter of chromatographic separation i; Vᵢ=sample volume aging parameter of chromatographic separation i; Eᵢ=eluent pH aging parameter of chromatographic separation 1; P, =pressure conditions aging parameter of chromatographic separation i; Sᵢ=solvent exchange aging parameter of chromatographic separation i and n=total number of chromatographic separations performed on the chromatography column.

All references cited in this specification are herewith incorporated by reference with respect to their entire disclosure content and the disclosure content specifically mentioned in this specification.

### FIGURE LEGENDS

FIG. 1: Schematic representation of an exemplary method of the invention.

FIG. 2: Factor contributing to chromatography column lifetime; a assay specific measurement adjustment factor (Sample amount, sample type, sample preparation. LC elution), β: onboard aging adjustment; & continuous prediction of column lifetime; γ initial prediction of column lifetime.

FIG. 3: Exemplary plot of remaining lifetime values over number of injections along with a regression line predicting end of usability of the column.

The following Examples shall merely illustrate the invention. They shall not be construed, whatsoever, to limit the scope of the invention.

### EXAMPLE 1

To overcome the shortcomings of the prior art, in particular of simple lifetime counters, the invention proposes the use of a weighted counter, optionally with several additional adjustment factors. This weighted counter takes into consideration the stress each individually injected sample has onto the column. Individual factors for different column aging effects may be stored in a databank and/or determined continuously.

Factors like the matrix type, sample preparation, sample dilution, and injection volume may be combined into one factor for each assay. e.g. as an assay weighting factor. The column lifetime after each injection is then adjusted by the assay-specific weighting factor. Since different assays can tolerate different stages of column aging, each assay may have its individual limit of measurements. These two factors define the lifetime of a column per assay and the described proceeding supports performing multiple assays on one column type.

Both of the aforesaid factors may be determined experimentally and stored in a database. In a multi-column setup (LC multiplexing), a column can be used for less demanding assays, while the lifetime of the column for a more demanding assay is reached and this assay is measured on a new column.

To take into account the individuality of each column, an adjustment factor (e.g. determined by release testing), which has impact on the maximum number of available measurements may additionally be used. Also, monitoring of chromatographic parameters (like retention time or resolution) can be used for a column usage factor which continuously adjusts the maximum number of injections dependent on the current column performance. This factor corrects for effects from individual samples. Both these factors may be determined by measurements carried out on the specific column. The adjustment factor for column individuality can be determined before column shipment and added to the database together with individual column properties, or it can be determined directly after column installation and be then written to the database. Determination of the adjustment factor for individual column usage may be done continuously during column usage and the factor directly adjusts the weighted counter.

Column onboard time can also have an impact on the column lifetime. Therefore, a factor for column onboard aging (e.g. exposure to elevated temperature) can be applied onto the lifetime calculation. This factor may be determined experimentally and stored in a database.

The aforesaid factors, alone or in combination, may be used to improve assay-dependent usage of a column. In a multi-column system, the instrument can switch demanding assays to a new column at the end of the lifetime of a column. During use, the user can be informed about the column health and remaining column lifetime with a display (e.g. a bar for the column lifetime).

### EXAMPLE 2

In an experiment, columns of the same type were used for different assays. The first column was subjected to injections with undiluted matrix samples, representing an assay for which a high sensitivity is required. After 7M) injections, the column was no longer usable.

For comparison, the matrix was diluted and injected to another column from the same batch as the first one with the same acquisition method. This represented an assay of an analyte which is present in a patient sample in a high concentration and therefore the sample may be diluted before the assay. With the diluted matrix samples, column lifetime was 2300 injections.

In conclusion, an injection with an undiluted matrix has to be weighted with a factor of 3.29 times higher than an injection using a diluted matrix sample.

### EXAMPLE 3

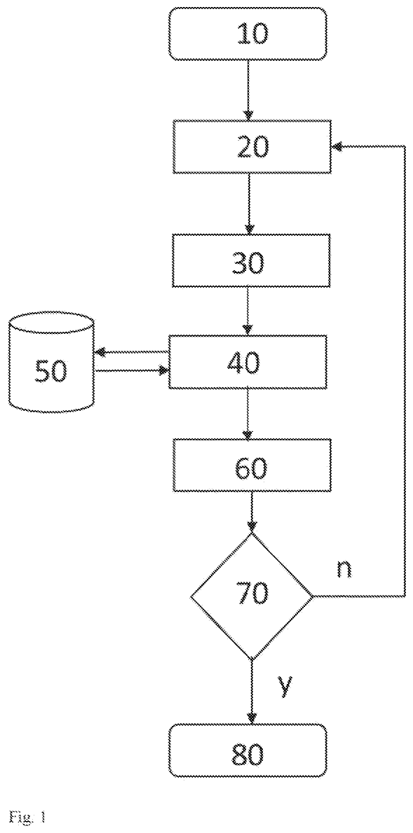

Referring to FIG. 1, an exemplary embodiment of a method of the invention is shown. After the method is started 10, a first lifetime value is provided 20 and a chromatographic separation is performed 30. Based on at least one aging parameter selected from sample type, sample dilution, and sample volume, a value of a weighted aging factor is determined 40. The weighted aging factor may e.g. be calculated based on an aging parameter factor, which may be retrieved from a data collection 50. As will be understood, the information required for said retrieval may be entered by a user, or may be provided e.g. by selection of the assay to be performed. Based on the weighted aging factor, a second lifetime value is calculated 60, which may be compared to a reference 70. Depending on the outcome of the comparison, the column use may end 80, or may continue with a further use, wherein the second lifetime value of step 60 may be used as the first lifetime value in step 20 of the next separation.

### EXAMPLE 4

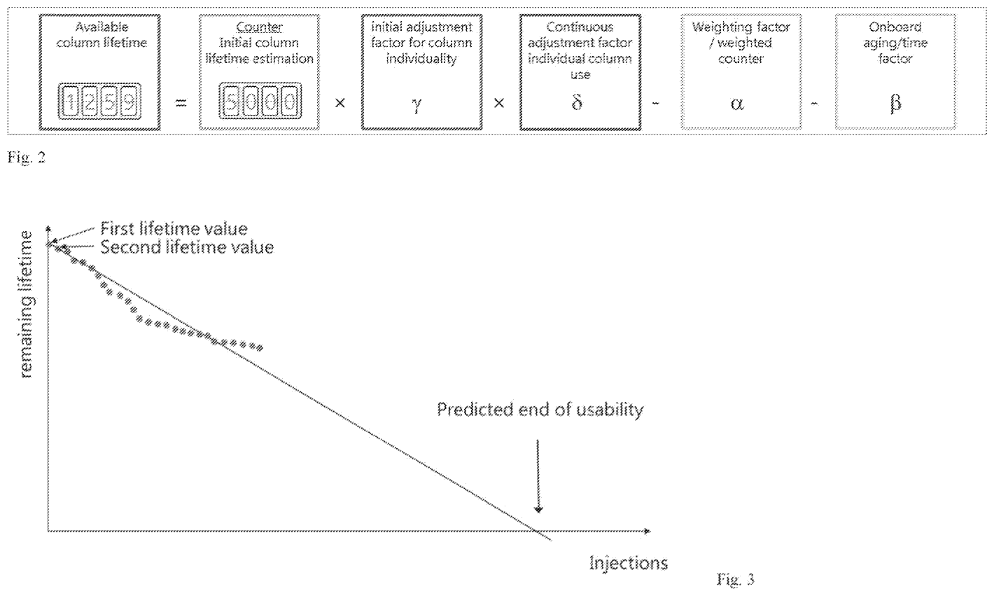

Referring to FIG. 2, several factors may contribute to chromatography column lifetime, in an embodiment as specified herein above. Based on the factors described, a lifetime can be calculated according to equ. (10):

Rᵢⱼ₊₁=Rₘ₀×γᵢ×δᵢⱼ−1×aₖ−βm×(tᵢⱼ−tᵢⱼ₋₁) (10),

with

| | | |
|---|---|---|
| R | column lifetime counts | |
| i | individual column | i = 1, . . . , I |
| j | individual injection | j = 0, . . . , J |
| k | individual assay | k = 1, . . . , K |
| m | column type | m = 1, . . . , M |

### EXAMPLE 5

A Table showing exemplary values of aging parameters and weighted aging factors and remaining lifetime values is shown in Table 1. FIG. 3 shows an exemplary use of the methods of the present invention in predicting end of usability of a chromatography column.

TABLE 1

| | | | | | | | | Weighted | |
|---|---|---|---|---|---|---|---|---|---|
| | | Sample | Injection | | Pressure | Solvent | Standby | aging | Remaining |
| Assay | Sample | preparation | vol. | Eluent pH | conditions | exchange | time | factor | lifetime |
| Steroids in | Serum +4 | Enrichment | 20 μL | Acidic +1 | High +3 | No 0 | None 0 | +16 | 9984 |
| Serum | | *2 | *1.5 | | | | | | |
| Opioids in | Urine +3 | Depletion 1:10 | 1 μL | Basic +6 | High +3 | Yes +2 | None 0 | +11.6 | 9972 |
| urine | | *0.1 | *1.1 | | | | | | |
| Vitamin D | Whole | Depletion 1:1 | 20 μL | Neutral +4 | Low +1 | Yes +2 | None 0 | +11.5 | 9960 |
| in whole | blood +6 | *0.5 | *1.5 | | | | | | |
| blood | | | | | | | | | |
| Standby | 0 | 0 | 0 | 0 | 0 | 0 | 16 hours +16 | +16 | 9944 |
| over night | | | | | | | | | |

### REFERENCE SIGNS

10 start
20 provision of first lifetime value
30 chromatographic separation
40 providing a value of a weighted aging factor
50 data collection
60 determination of second lifetime value
70 second lifetime value exceeds reference? (y: yes, n: no)
80 end of column use

### LITERATURE

EP 2,771,683 A1
EP 2,338,049 A1
EP 2,880,437 A1
U.S. Pat. No. 8,279,072 B2

1. A method for operating a chromatography column, the method comprising:
providing a first value of a lifetime of said chromatography column;
performing a chromatographic separation of a sample on said chromatography column;
providing a value of a weighted aging factor determined based on at least one aging parameter selected from sample type, sample dilution, and sample volume; and
determining a second value of said lifetime of said chromatography column based on said first value and said value of the weighted aging factor.

2. The method of claim 1, wherein said sample type is defined by sample matrix and/or pre-purification state of said sample.

3. The method of claim 1, wherein said value of the weighted aging factor is calculated based on at least one further aging parameter selected from time since a preceding use, storage conditions since a preceding use, and set of chromatography conditions applied.

4. The method of claim 1, wherein
said aging parameters are combined into a single, assay-specific weighted aging factor.

5. The method of claim 1, wherein further comprising comparing said second value to a reference value.

6. The method of claim 5, wherein a use of said chromatography column is discontinued or modified based on the result of comparing aid second value to said reference value; and
wherein said modified use comprises at least one of repacking said chromatography column or reserving said chromatography column for applications in which lower performance is required.

7. The method of claim 1, wherein said weighted aging factor is calculated as a product of a sample type aging parameter, a sample dilution aging parameter, and a sample volume aging parameter.

8. The method of claim 7, wherein said second value is calculated as the first value in addition to or less the weighted aging factor.

9. The method of claim 1, wherein providing said first value of said column is based on an initial value of said lifetime and the weighted aging factors of any preceding uses of said chromatography column.

10. The method of claim 1, wherein determining the second value is further based on at least one of:
(i) a parameter indicating the initial performance of said chromatography column;
(ii) a parameter indicating the performance requirement of the assay used;
(iii) a parameter indicating current performance of said chromatography column; and
(iv) a parameter indicating onboard aging.

11. (canceled)

12. The method of claim 1, wherein providing the value of aid weighted aging factor comprises providing a value of a weighted aging factor determined based on (i) at least one sample specific aging parameter selected from sample type, sample dilution, and sample volume; and (ii) at least one operation specific aging parameter.

13. The method of claim 12, wherein said operation specific aging parameter is at least one of an assay specific parameter, a time since a preceding use, storage conditions since a preceding use, or a parameter indicative of a solvent exchange.

14. The method of claim 13, wherein said assay specific parameter is at least one of an eluent pH or a pressure condition.

15. A method of generating annotated aging parameter categories and aging parameter factors, for a chromatography column, the method comprising
determining at least one first value of a performance parameter of the chromatography column;
performing at least one chromatographic separation under conditions of a first set of aging parameter category values;
determining at least one second value of said performance parameter;
performing at least one, chromatographic separation under conditions of a second set of aging parameter category values, wherein said second set of aging parameter category values is non-identical to said first set of aging parameter category values;
determining at least one third value of said performance parameter; and
determining, based on said first, second, and third performance parameters and on said first and second set of aging parameter category values, a value of an aging parameter factor for at least one aging parameter category and annotating the values of said at least one aging parameter category and said aging parameter factor into a data collection.

16. (canceled)

17. A device for determining a second lifetime value of a chromatography column, comprising:
a storage medium comprising a data collection tangibly embedded therein, said data collection comprising:
at least one set of an aging parameter factor value annotated to an aging parameter category value, wherein said aging parameter category value comprises at least one category value of an aging parameter selected from sample type, sample dilution, and sample volume; and
at least one of a first lifetime value of said chromatography column or an initial lifetime value of said chromatography column,
an input unit that receives input data indicative of at least one aging parameter factor value; and
a data processing unit that calculates a second lifetime value of said chromatography column based on at least one of said input data indicative of at least one aging parameter factor value, said first lifetime value of said chromatography column, or said initial lifetime value of said chromatography column.

18. (canceled)

19. The method of claim 10, wherein the parameter indicating the initial performance of said chromatography column is determined upon released testing.

20. The method of claim 10, wherein the parameter indicating onboard aging is indicative of at least one of time or temperature of column keeping.

21. The method of claim 17, wherein the aging parameter factor value is further annotated to a chromatographic protocol.
